(19) United States
(12) Patent Application Publication
(10) Pub. No.: US 2026/0029750 A1
(43) Pub. Date: Jan. 29, 2026

(54) MANUFACTURING METHOD, APPARATUS AND HOLOGRAM PLATE

(71) Applicant: AlphaLum SA, Lausanne (CH)

(72) Inventors: Eric Tremblay, Lausanne (CH); Carlos Macias, Pully (CH)

(21) Appl. No.: 18/996,291

(22) PCT Filed: Jul. 18, 2023
(86) PCT No.: PCT/EP2023/069873

§ 371 Date: Jan. 17, 2025

(30) Foreign Application Priority Data
Aug. 18, 2022 (DE) 102022120907.5

(51) Int. Cl. G03H 1/04; G03H 1/02

(52) U.S. Cl. CPC G03H 1/0402; G03H 1/0248; G03H 2222/12; G03H 2240/11; G03H 2260/12

(57) ABSTRACT

In one embodiment, a method for manufacturing a holographic plate includes providing recording geometry optics, providing a photopolymer and illuminating the photopolymer simultaneously with a first laser beam and a second laser beam thereby generating a holographic pattern in a pattern area of the photopolymer, wherein the illuminated photopolymer results in the holographic plate.

### CROSS-REFERENCE TO RELATED APPLICATIONS

This patent application is a national phase filing under section 371 of PCT/EP2023/069873, filed Jul. 18, 2023, which claims the priority of German patent application no. 102022120907.5, filed Aug. 18, 2022, each of which is incorporated herein by reference in its entirety.

### TECHNICAL FIELD

A method for manufacturing a holographic plate, an apparatus for carrying out such a method, and a fan-out hologram plate are provided.

### BACKGROUND

Document US 2011/0200918 A1 refers to a photosensitive composition for volume hologram recording.

Document G. Kopitkovas et al., “Fabrication of beam homogenizers in quartz by laser micromachining” in Journal of Photochemistry and Photobiology A: Chemistry, Volume 166, Issues 1-3, 12 Aug. 2004, Pages 135-140, refers to a manufacturing method for generating a pattern.

### SUMMARY

Embodiments provide a holographic plate for a wearable augmented reality, AR, display, such as a head-mounted AR display, with improved field of view quality.

In the method described herein, for example, a recording geometry optics is used to produce the fan-out hologram plate which comprises a lens array. By means of the lens array, a first laser beam is divided in a plurality of sub-beams, and each one of the sub-beams completely or nearly complete illuminates a pattern area of the fan-out hologram plate. Hence, a high image quality in the display using the fan-out hologram plate can be achieved for a whole field of view, FoV.

According to at least one embodiment, the method comprises the step of providing a photopolymer. The photopolymer is sensitive on illumination, in particular on illumination with near-ultraviolet, visible and/or near-infrared radiation. Near-ultraviolet refers to the spectral range between 320 nm and 419 nm, visible radiation refers to the spectral range between 420 nm and 780 nm, and near-infrared radiation refers to the spectral range between 781 nm and 1.3 μm. For example, the photopolymer is configured to change its refractive index upon illumination. Some possible photopolymers are described, for example, in document US 2011/0200918 A1, see especially paragraphs 35 to 57; the disclosure content of this document in included by reference.

According to at least one embodiment, the method comprises the step of providing recording geometry optics. For example, the recording geometry optics is a transmission optics. Otherwise, the recording geometry optics can also be a reflection optics, or a mixture of transmission and reflection optics. For example, the recording geometry optics is configured for near-ultraviolet, visible and/or near-infrared radiation.

According to at least one embodiment, the method comprises the step of illuminating the photopolymer simultaneously with a first laser beam and a second laser beam. By this kind of illumination, the first and second laser beams interfere at the photopolymer and an intensity pattern results. Based on this intensity pattern, for example, a local refractive index and/or a cross-link rate is defined in the photopolymer.

Hence, by means of said illumination a holographic pattern is generated in a pattern area of the photopolymer, the illuminated photopolymer results in the holographic plate. It is possible that after illumination with the first and second laser beams the photopolymer needs to be finished, for example, hardened. This may be done thermally, for example, by applying heat to the photopolymer or by applying near-infrared radiation, like laser radiation, to the photopolymer. However, the latter illumination preferably does not have any significant influence on the holographic pattern, although minor shrinkage may occur; for example, a shrinkage rate due to heating is less than 5% or is less than 2%. Said shrinkage rate may be considered in designing the interference pattern of the first and second laser beams.

According to at least one embodiment, only the first laser beam runs through the recording geometry optics. Hence, the second laser beam may not come in optical interaction with the recording geometry optics. ‘Run through’ refers to optical interaction, that is, beam shaping and/or redirecting. For transmission optics, indeed the first laser beam may be transmitted through the recording geometry optics; in case of reflection optics, ‘run through’ means that the first laser radiation is reflected at least once at the recording geometry optics.

According to at least one embodiment, a light-entrance face of the recording geometry optics for the first laser beam faces away from the photopolymer, and a light-exit face of the recording geometry optics faces the photopolymer. It is possible that the light-entrance face and the light-exit face are the only optically active faces of the recording geometry optics. These faces could be refractive or also reflective faces, or a mixture thereof. It is possible that these faces are the only optically relevant faces of the recording geometry optics. Otherwise, there can be one or a plurality of intermediate optically relevant faces between the light-entrance face and the light-exit face, like additional refractive faces to shape the first laser beam.

According to at least one embodiment, the recording geometry optics comprise a lens array which divides the first laser beam into a plurality of sub-beams. The term ‘lens array’ may refer to refractive lenses, but may also read on an array for refractive mirrors. As in this respect a lens array is optically equivalent to a mirror array, in the following only the term ‘lens array’ is used although a mirror array may also be included.

For example, a number of the sub-beams is at least five or is at least ten or is at least 20 or is at least 50. Alternatively or additionally, the number of sub-beams is at most 10⁴ or is at most 10³ or is at most 200 or is at most 64.

According to at least one embodiment, each one of the sub-beams illuminates most or all of the pattern area. For example, this means that at least 50% or at least 70% or at least 85% or at least 95% or at least 98% of the pattern area is illuminated by each one of the plurality of sub-beams. Hence, each one or most of the sub-beams may partially or completely overlap with all other sub-beams or with most of the other sub-beams. ‘Most of’ may mean at least 60% or at least 90%.

In at least one embodiment, the method is for manufacturing a holographic plate and comprises the following steps, for example, in the stated order:
providing recording geometry optics,
providing a photopolymer, and
illuminating the photopolymer simultaneously with a first laser beam and a second laser beam and thus generating a holographic pattern in a pattern area of the photopolymer, the illuminated photopolymer results in the holographic plate, wherein
only the first laser beam runs through the recording geometry optics,
a light-entrance face of the recording geometry optics for the first laser beam faces away from the photopolymer, and a light-exit face of the recording geometry optics faces the photopolymer,
the recording geometry optics comprise a lens array which divides the first laser beam into a plurality of sub-beams, and
each one of the sub-beams illuminates most of the pattern area;
   as an option, each one of the sub-beams has a focal point between the pattern area and the light-entrance face, a secondary optical element is a converging lens and is located in a plane of the focal points of the sub-beams, and the lens array is composed of a plurality of spherical lenses.

Hence, the method described herein is, for example, to improve sub-pupil image overlap in a multiplexed fan-out hologram. The hologram is used, for example, as an AR pancake lens combiner, and may be applied in a near-eye display for AR or also for virtual reality, VR.

A technical problem solved by this method is avoiding missing parts of the field of view in each sub-pupil of an eyebox. Such missing parts can be caused by the recording geometry optics. When a lens array is used to create the sub-pupils, each lens forms a point, each of which is a point-to-point hologram to be recorded. In a basic configuration, each of these points are identical with beams of light expanding away from the spatially separated points with the same angular content. On the holographic material, however, if no particular care is taken, these beams to not completely overlap. The result of this in the final near-eye display is that only parts of the hologram, and consequently of the image, where there is complete overlap of the light from the multiplexed points will sent the image information to all sub-pupils. Away from the image center, information will only be sent to some of the final sub-pupils.

Especially in near-eye displays supporting, for example, three-dimensional, 3D, AR and VR, a key factor in determining the user experience is the size of the eyebox. The eyebox refers in particular to a volume where the eye receives an acceptable view of the image.

For example, the technical features used herein to solve this problem are, inter alia, to use a set of optical components to generate spatially separated point sources and converge their light toward the same region of the hologram for recording. This can be done in several ways.

For example, some embodiments use a lens array to generate the point sources, followed by a large positive power field lens to converge the beams of light toward the hologram at the desired offset distance. Other embodiments use a single two-sided optical element, where one side of the element contains a single powered lens and the other side contains a lenslet array; compared to the previously mentioned embodiments, this solution has only a single optical element. Still further embodiments use a single element with only one side shaped, and the other side being planar; in this case, the lenslets are appropriately shaped, to both focus and converge the light; these lenslets could be considered free-form in shape. Compared to the aforementioned embodiments, the latter provide a single element with only one side optically active, and therefore may improve the holographic recording due to less surfaces reflecting and scattering, and may also be less costly or more accurate to produce as being optically single sided.

As mentioned, the converging sub-beams allow each point on the hologram, and therefore the image, to be propagated into all of the sub-pupils that make up the eyebox.

According to at least one embodiment, each one of the sub-beams has a focal point between the photopolymer, that is, the pattern area, and the light-entrance face. The focal point is not necessarily a focus of the respective sub-beam, that is, a focus spot with a beam waist having a diameter determined by its wavelength and its total angular spread. For example, the focal point is at a cross-section of the respective sub-beam where said sub-beam has its minimum diameter, in particular a minimum diameter at full width of half maximum, FWHM. Hence, some power of said sub-beam is located outside the FWHM diameter.

According to at least one embodiment, each one of the sub-beams illuminates at least 98% or all of the pattern area. Hence, each one of the sub-beams overlaps completely or nearly completely with all other sub-beams. ‘Nearly completely’ may mean that an overlap is at least 90% or at least 98% of an area of the smaller one of the respective two overlapping sub-beams.

According to at least one embodiment, the light-entrance face is of convex fashion. That is, the light-entrance face has a converging effect.

According to at least one embodiment, the light-entrance face is of planar fashion. Hence, the light-entrance face may not or not significantly refract the first laser beam. For example, the first laser beam is a parallel bundle of rays arriving perpendicular at the light-entrance face.

According to at least one embodiment, the lens array is located at the light-exit face. Otherwise, the lens array could also be located at the light-entrance face, or the lens array could be spread so that the light-entrance face and the light-exit face together define the lens array.

According to at least one embodiment, an optical axis of the light-exit face and/or of the recording geometry optics is oriented perpendicular to the photopolymer, that is, the pattern area. Hence, the lens array may be arranged in parallel with the photopolymer and/or the pattern area. This may also mean that the optical axis of the light-exit face and/or of the recording geometry optics and an optical axis of the pattern area are in parallel with one another or are congruent or identical; in this case, for example, the pattern area and/or the photopolymer and/or the holographic plate may be of curved fashion.

According to at least one embodiment, the lens array is composed of a plurality of spherical lenses. Otherwise, the lens array can be composed of a plurality of parabolic or elliptic or tubular lenses. Hence, a surface of the lenses of the lens array, seen in cross-section through an optical axis of the respective lens, corresponds to part of a circle, a parabola, an ellipse or a cylinder. Alternatively or additionally, this may mean that the lenses have at least two different planes of mirror symmetry.

According to at least one embodiment, the lens array is composed of a plurality of free-form lenses. This means, for example, that the surface of the lenses of the lens array, seen in cross-section through the optical axis of the respective lens, does not correspond to part of any one of a circle, a parabola, an ellipse or a cylinder. Alternatively or additionally, this may mean that the lenses have one or none plane of mirror symmetry. Seen in any cross-section through a center point of the respective lens, the lenses may be asymmetric.

It is possible that free-form lenses and lenses having at least two different planes of mirror symmetry are combined with each other in the lens array.

According to at least one embodiment, the focal points of the sub-beams are located between the light-exit face and the photopolymer. Hence, between the recording geometry optics and the pattern area there are the focal points.

According to at least one embodiment, the recording geometry optics is composed of a single optical element. That is, the only optically relevant face or faces of the recording geometry optics may be the light-entrance face and/or the light-exit face.

According to at least one embodiment, the recording geometry optics is composed of a plurality of individual optical elements. For example, the recording geometry optics is composed of at most five or of at most three or of two optically relevant elements, like lenses.

According to at least one embodiment, the recording geometry optics is composed of a primary optical element and of a secondary optical element. Hence, the recording geometry optics comprises exactly two optical elements.

According to at least one embodiment, the primary optical element carries the light-entrance face and the lens array.

The secondary optical element is located between the primary optical element and the photopolymer.

According to at least one embodiment, the secondary optical element is a converging lens. For example, the secondary optical element is a plane-convex or a bi-convex lens.

According to at least one embodiment, the secondary optical element is located in a face, like a plane, of the focal points of the sub-beams. This means, for example, that a principle plane of the secondary optical element or a surface of the secondary optical element facing the first optical element or the light-exit face is located in the face of the focal points. The face of the focal points, which is preferably a plane, may be a virtual face.

According to at least one embodiment, a diameter of the pattern area is at least 1 cm or is at least 2 cm. Alternatively or additionally, said diameter is at most 10 cm or is at most 6 cm.

According to at least one embodiment, a structural size of the holographic pattern is at least 0.1 μm or is at least 0.2 μm. Alternatively or additionally, said structural size is at most 0.7 μm or is at most 0.4 μm or is at most 0.3 μm. The structural size refers, for example, to a minimum distance between maxima and minima of a refractive index and/or a geometric structuring of the holographic pattern in the pattern area.

According to at least one embodiment, the first laser beam and/or the second laser beam each have a wavelength of maximum intensity between 350 nm and 870 nm inclusive. Otherwise, the first laser beam and/or the second laser beam are of near-ultraviolet radiation and/or of near-infrared radiation.

According to at least one embodiment, the finished holographic plate is a volume phase hologram, VPH, plate. Hence, the finished holographic plate comprises a pattern of low-refractive and high-refractive index regions, especially within a volume of the holographic plate. For example, the holographic plate is configured for visible light, like blue light, green light and red light. For example, blue refers to wavelengths between 440 nm and 485 nm, green light to wavelengths between 520 nm and 555 nm, and red light to wavelengths between 600 nm and 685 nm.

An apparatus is additionally provided. By means of the apparatus, a holographic plate is produced in a way as indicated in connection with at least one of the above-stated embodiments. Features of the apparatus are therefore also disclosed for the method and vice versa.

In at least one embodiment, the apparatus comprises means for carrying out the method stated above, for example, the apparatus comprises the recording geometry optics, a first laser for generating the first laser beam, a second laser for generating the second laser beam, and a support arrangement for handling the photopolymer and, thus, the holographic plate.

A fan-out hologram plate is additionally provided. The fan-out hologram plate is produced by means of the method and/or an apparatus as indicated in connection with at least one of the above-stated embodiments. Features of the fan-out hologram plate are therefore also disclosed for the method as well as the apparatus and vice versa.

In at least one embodiment, the fan-out hologram plate comprises:
a holographic plate which is a volume phase hologram, VPH, plate and which includes a holographic pattern in a pattern area,
a polarization-dependent reflector on which the holographic plate is applied, and
a retarder which comprises, or which is configured to act as, a quarter-wave plate, the polarization-dependent reflector is located between the holographic plate (2) and the retarder,
wherein
the fan-out hologram plate is configured for augmented reality and/or for virtual reality glasses,
the holographic pattern comprises a multiplexed fan-out hologram,
a diameter of the pattern area is between 1 cm and 6 cm inclusive, seen in top view of the holographic plate and a structural size of the holographic pattern is between 0.2 μm and 0.7 μm inclusive, and
the holographic pattern is configured for a plurality of sub-pupils, each sub-pupil is configure for a full field of view, FoV, or for a nearly full FoV.

### BRIEF DESCRIPTION OF THE DRAWINGS

A method, an apparatus and a fan-out hologram plate described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

FIG. 1 is a schematic block diagram of an exemplary embodiment of a method for producing fan-out hologram plates described herein;

FIG. 2 is a schematic sectional view of an exemplary embodiment of an apparatus for producing fan-out hologram plates described herein;

FIG. 3 is a schematic sectional view of a method step of a modification of a method for producing a hologram plate;

FIGS. 4 to 7 are schematic sectional views of method steps of exemplary embodiments of methods for producing fan-out hologram plates described herein;

FIGS. 8 and 9 are schematic sectional views of exemplary embodiments of fan-out hologram plates described herein;

FIG. 10 is a schematic perspective view of an application of an exemplary embodiment of a fan-out hologram plates described herein;

FIG. 11 is a schematic perspective view of an exemplary embodiment of a wearable augmented reality display including a fan-out hologram plate described herein; and

FIGS. 12 and 13 are schematic sectional views of exemplary embodiments of wearable augmented reality displays including fan-out hologram plates described herein.

### DETAILED DESCRIPTION OF ILLUSTRATIVE EMBODIMENTS

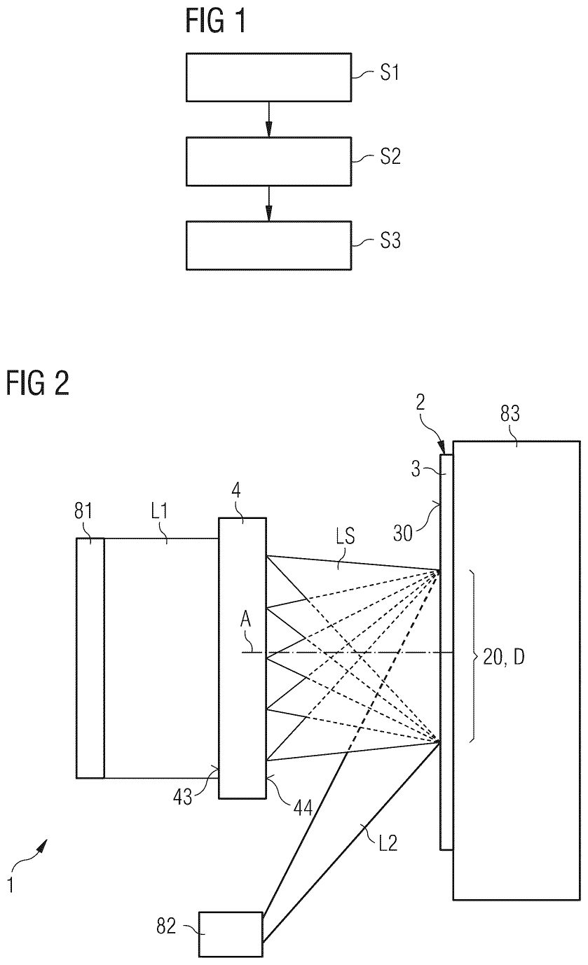

FIG. 1 schematically illustrates an exemplary embodiment of a method by means of which holographic plates 2 are produced.

In a method step S1, recording geometry optics 4 are provided. Optionally, method step S1 may include that an apparatus 1 is provided which comprises all necessary fix equipment for carrying out the method.

Then, in a method step S2, a photopolymer 3 is provided. For example, the photopolymer 3 is placed and optionally adjusted in the apparatus 1.

In subsequent method step S3, the photopolymer 3 is simultaneously illuminated with a first laser beam L1 and a second laser beam L2, see also below FIG. 2, for example. Thus a holographic pattern 22 is generated in a pattern area 20 of the photopolymer 3.

The illuminated photopolymer 3 results in the holographic plate 2, for example, after finishing the photopolymer 3. Finishing can be done, for example, by thermal and/or chemical treatment. Said finishing is not illustrated in the figures.

In FIG. 2, method step S3 as well as the apparatus 1 are explained in more detail. For generating the first laser beam L1 and the second laser beam L2, the apparatus 1 comprises a first laser 81 and a second laser 82, respectively. The lasers 81, 82 can have the same peak wavelength or can also have different peak wavelengths. In case of a single peak wavelength, it is possible that there is one common laser source for both beams L1, L2 led along optically different paths.

For handling the photopolymer 3 and the resulting holographic plate 2, which is, for example, a volume phase hologram, VPH, plate, the apparatus 1 includes a support arrangement 83. By means of the support arrangement 83, the photopolymer 3 and the resulting holographic plate 2 can be inserted, can exactly be placed, can be finished and/or can be driven out of the apparatus 1, for example. Thus, the support arrangement 83 can include holders, motors, belt conveyors, or the like, not illustrated. A top face 30 of the photopolymer 3 faces away from the support arrangement 83.

The recording geometry optics 4 is illustrated in FIG. 2 as an abstract component. However, the recording geometry optics 4 comprises a light-entrance face 43 facing away from the photopolymer 3 and an opposite light-exit face 44 facing the photopolymer 3. For example, an optical axis A of the recording geometry optics 4 is oriented perpendicular to the photopolymer 3.

The first laser beam L1 arrives at the light-entrance face 43 as a bundle of parallel rays and in parallel with the optical axis A. The first laser beam L1 illuminates the light-entrance face 43 to a large extend. That is, the light-entrance face 43 is virtually completely lighted by the first laser beam L1. The second laser beam L2 travels distant from the recording geometry optics 4 and is not optically handled by means of the recording geometry optics 4. The second laser beam L2 thus may directly and completely illuminate a pattern area 20 of the photopolymer 3. For example, the pattern area 20 has a diameter D which may be around one inch.

If the pattern area 20 is not of circular fashion, then for the diameter D it applies: D=(4A/π)^{1/2}, wherein A is an area content of the pattern area 20; this applies analogously for any other diameters referred to herein. Preferably, the pattern area 20 is of circular fashion, or is of nearly circular fashion. ‘Nearly circular’ may mean that a quotient of a longest chord divided by a shortest chord through a centroid of the pattern area 20 is at most two or is at most 1.5 or is at most 1.2.

The recording geometry optics 4 comprises means for splitting the areal first laser beam L1 into a plurality of sub-beams LS. For this purpose, the recording geometry optics 4 can comprise a lens array 41 or the like, not shown in FIG. 2. The sub-beams LS each travel towards the top face 30. Moreover, each one of the sub-beams LS completely or virtually completely illuminates the pattern area 20. Accordingly, at the top face 30 each one of the sub-beams LS overlaps with all other sub-beams LS as well as with the second laser beam L2. Hence, a desired holographic pattern 22 can be produced throughout the complete pattern area 20.

To achieve overlap of all the sub-beams LS, at least some of the individual optical axes of the sub-beams LS are not in parallel with the overall optical axis A of the recording geometry optics 4 as a whole. For example, all the individual optical axes of the sub-beams LS are inclined towards the overall optical axis A; this may apply for all the individual optical axes not being next to or congruent with the overall optical axis A. The individual optical axes may be that directions along which a maximum intensity of the respective sub-beam LS is emitted and/or may be a center line of a radiation cone of the respective sub-beam LS.

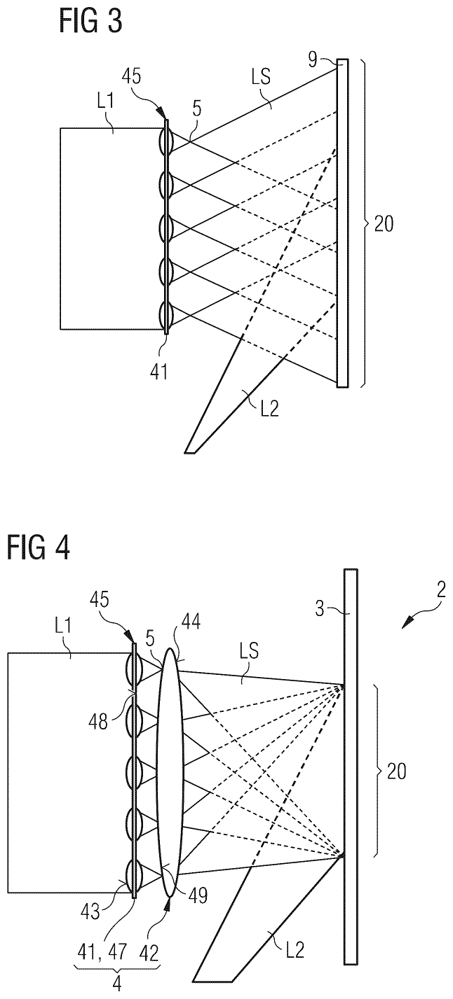

Contrary to that, in the modification of the apparatus as shown in FIG. 3, the sub-beams LS have individual optical axes arranged in parallel with one another resulting from a planar lens array 41 composed of two-dimensionally arranged spherical lenses 45. Hence, the sub-beams LS only partially overlap with each other.

Consequently, there is a poor overlap on the VPH which leads to missing parts in a field of view in each resulting sub-pupil when the holographic plate is used in an AR/VR display, see below. For high image quality in an AR/VR display, overlap of all or most of the multiplexed beams is required for all points of the image to be represented in all subpupils of an eyebox. With the method and apparatus as illustrated in FIG. 2, improved recording can be achieved enabling a significant overlap of the sub-beams LS so that full FoV is present in all sub-pupils of the eyebox.

In FIG. 4, one exemplary embodiment of the recording geometry optics 4 is illustrated in more detail. This recording geometry optics 4 is composed of a primary optical element 47 and of a secondary optical element 42. The light-entrance face 43 is at the primary optical element 47, and the light-exit face 44 is at the secondary optical element 42. Further, the primary optical element 47 has a first intermediate face 48 remote from the light-entrance face 43, and the secondary optical element 42 has a second intermediate face 49 remote from the light-exit face 44.

For example, the primary optical element 47 is shaped as the lens array 41 wherein either the light-entrance face 43 or the first intermediate face 48 or both can form the lenses 45 of the lens array 41. For example, the lenses 45 are spherical lenses.

For example, the secondary optical element 42 is a bi-convex lens. Hence, both the light-exit face 44 and the second intermediate face 49 can be of curved fashion.

By means of the lenses 45, the individual sub-beams LS each have a focal point 5. All the focal points 5 may be located or approximately located in a common plane. For example, said common plane is a principle plane of the secondary optical element 42 facing the first optical element 47.

For example, a distance between the light-exit face 43 and the top face 30 of the photopolymer 3 is at least 10 mm and/or is at least 25% of the diameter D of the pattern area 20. Alternatively or additionally, said distance is at most 80 mm and/or is at most 300% of the diameter D of the pattern area 20. It is possible that a diameter of the first laser beam L1 at the light-entrance face 43 is at least 50% and/or is at most 200% of the diameter D of the pattern area 20.

Thus, according to FIG. 4 a positive power field lens placed near the focal points 5 of the lenslets 45 changes the direction of the light without significantly adding optical power.

Otherwise, the same as to FIGS. 1 to 3 may also apply to FIG. 4, and vice versa.

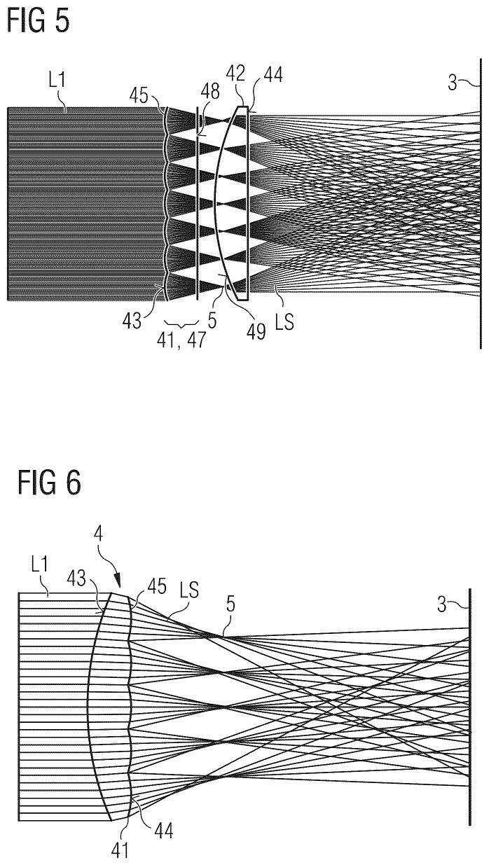

In FIG. 5, another embodiment of the recording geometry optics 4 is illustrated. In this case, the recording geometry optics 4 is also composed of the primary and secondary optical elements 42, 47, like in FIG. 4. According to FIG. 5, the light-entrance face 43 only is provided with the lens array 41, and the first intermediate face 48 is of planar fashion. The secondary optical element 47 is a plane-convex lens wherein the second intermediate face 49 is curved and the light-exit face 44 is plane. The focal points 5 are located close to the second intermediate face 49, for example, at a distance of at most 0.1 D or of at most 0.05 D. It is possible that the focal points 5 are located on a convex face, wherein it is possible that said convex face and the second intermediate face 49 have the same kind of curvature, that is, positive or negative curvature, while an absolute value of a radius of curvature of the second intermediate face 49 can be smaller than that of said convex face.

Otherwise, the same as to FIGS. 1 to 4 may also apply to FIG. 5, and vice versa.

In the embodiment of FIG. 6, the recording geometry optics 4 is a single optical element. Thus, between the light-entrance face 43 and the light-exit face 44 there are no intermediate faces so that reflections or disturbances at such faces can be avoided.

For example, the light-entrance face 43 is of convex fashion, and the light-exit face 44 carries the lens array 41. It is possible in this configuration that the lens array 41 is composed of the spherical lenses 45. Like in FIGS. 4 and 5, individual optical axes of the lenses 45 can be oriented in parallel with one another and in parallel with the overall optical axis A. As due to the curved light-entrance face 43 the radiation of the first laser beam L1 arrives at the lenses 45 along slightly different directions, the sub-beams LS run along different directions.

Otherwise, the same as to FIGS. 1 to 5 may also apply to FIG. 6, and vice versa.

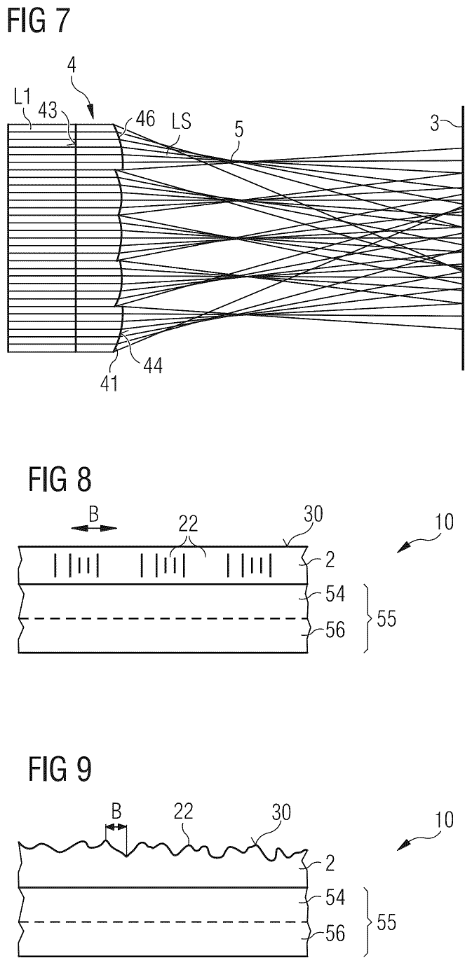

According to FIG. 7, the recording geometry optics 4 is a single optical element, too, as in FIG. 6. However, the light-entrance face 43 is plane, and the light-entrance face 44 comprises the lens array 41. The lenses 46 are free-form lenses. Other than in the previous embodiments, there are not separate optical faces for defining the directions of the sub-beams LS and for focusing the sub-beams LS, but the lenses 46 at the single optically active face 44 serve both for defining the directions of the sub-beams LS as well as for focusing the sub-beams LS.

Again, the sub-beams LS have focal points 5 between the light-exit face 44 and the photopolymer 3. For example, like in FIG. 6, the focal points 5 can be closer at the light-exit face 44 than at the photopolymer 3. Further, in FIG. 7 it can be seen that the focal points 5 need not to be exact focal points but can be blurred.

Otherwise, the same as to FIGS. 1 to 6 may also apply to FIG. 7, and vice versa.

In FIGS. 4 to 7, the recording geometry optics 4 are illustrated in each case to be refractive optics. However, it is also possible that all this recording geometry optics 4 can analogously be implemented as reflective optics.

In FIGS. 8 and 9, fan-out hologram plates 10 comprising the finished holographic plate 2 are shown. Optionally, the fan-out hologram plates 10 include a polarization-dependent reflector 54 and a retarder 56, wherein the holographic plate 2 is located at the polarization-dependent reflector 54. The components 54, 56 can compose a carrier 55 for the holographic plate 2.

According to FIG. 8, the holographic plate 2 is a volume phase hologram, VPH, plate. Thus, the holographic plate 2 comprises a plurality of regions with low and with high refractive index, symbolized as a pattern of dashes. These refractive index modulations result in the holographic pattern 22. For example, a structural size B of the holographic pattern 22 is about 0.2 μm. According to FIG. 9, the holographic pattern 22 is realized by a surface structure.

Both kinds of holographic patterns 22 as shown in FIGS. 8 and 9 can be applied to all the embodiments of the holographic plate 2.

Otherwise, the same as to FIGS. 1 to 7 may also apply to FIGS. 8 and 9, and vice versa.

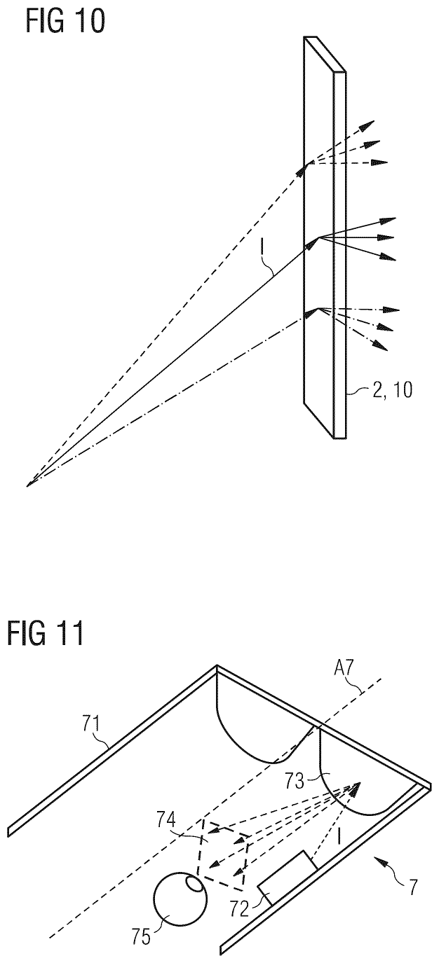

The optical function of the holographic plate 2 is shown in more detail in FIG. 10. The holographic plate 2 is configured to selectively spread or fan-out light incident on the holographic plate 2 according to an angle of incidence of the light incident on the holographic plate 2. Specifically, the holographic plate 2 is configured to spread or fan-out image light I incident on the holographic plate 2 at higher angles of incidence but to transmit ambient light from an opposite direction without spreading or fanning-out the ambient light. This can be achieved by the holographic pattern 22 of the holographic plate 2.

Referring to FIG. 11, a wearable AR display 7 is shown. The display 7 comprises a support frame 71 with a central axis A7 and an optical system in the form of an off-axis retinal scanning display mounted on the support frame 71. The optical system comprises an image generator in the form of a scanning laser projector 72 emitting the image light I and an eyepiece 73. The projector 72 is offset from the central axis A7.

In use, when the support frame 71 is mounted on a head of a user with the eyepiece 73 positioned in a field of view of the user, the eyepiece 73 transmits ambient light from a scene located in front of the eyepiece 73 through the eyepiece 73 to an eye 75 of the user located behind the eyepiece 73. The projector 72 projects the linearly-polarized image light I defining an image towards the eye 75 of the user by way of the eyepiece 73. The linearly-polarized image light I may include one or more wavelengths such as one or more of red light, green light or blue light.

The eyepiece 73 replicates the image defined by the projected image light I a number of times at a plurality of positions in a plane 74 at the eye 75 of the user to expand an eyebox of the wearable AR display 7.

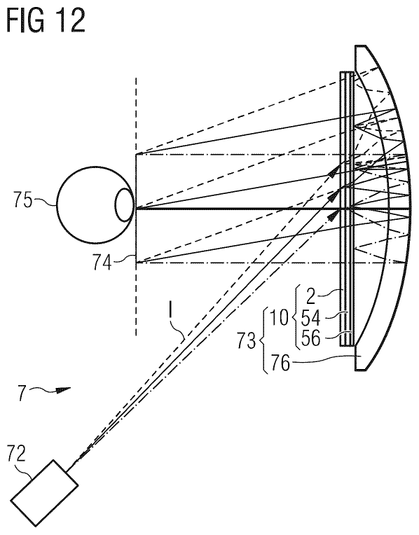

FIG. 12 illustrates the optical system in use replicating an image defined by three different linearly-polarized principal rays constituting the image light I at three different positions in the plane 74 at the eye 75 of the user to provide an expanded eyebox for each principal ray of the projected image light I.

The eyepiece 73 includes the fan-out hologram plate 10 with the holographic plate 2 which functions as an optical spreader for fanning-out the projected image light I to form spread image light. The eyepiece 73 further includes an optical combiner in the form of a ‘reflective pancake’ optical combiner 76 for collimating the spread image light and for reflecting the collimated light back through the holographic plate 2 to form collimated light which propagates to the plane 74 to provide the expanded eyebox in the plane 74.

The reflector 76 has a first or front side disposed towards the scene and a second or rear side disposed towards the holographic plate 2. At the front side, there is a circular polarizer, at the rear side, there is a dichroic reflective coating configured to be highly reflecting in one or more narrow spectral bands, each narrow spectral band being arranged around a corresponding wavelength of the image light I, but to transmit light at other wavelengths of the ambient light. The fan-out hologram plate 10 includes the polarization-dependent reflector 54, the retarder 56 which comprises, or which is configured to act as, a quarter-wave plate.

The polarization-dependent reflector 54 and the dichroic reflective coating of the optically-powered reflector 76 define an optical cavity, wherein the retarder 56 is located in the optical cavity. Moreover, the polarization-dependent reflector 54 and the optically-powered reflector 76 are arranged so that the polarization-dependent reflector 54 is located in an optical path between the holographic plate 2 and the optically-powered reflector 76. The retarder 56 and the optically-powered reflector 76 are separated, for example, by an air gap.

In use, the ambient light which is incident on the front side of the optical combiner 76 is effectively combined with the collimated light which exits the rear side of the optical combiner 76. Specifically, the circular polarizer imparts a circular polarization to the ambient light and the circularly-polarized ambient light is incident on the front side of the optical combiner 76 defined by the dichroic reflective coating. The dichroic reflective coating transmits, towards the retarder 56, the wavelengths of the circularly-polarized ambient light which fall outside the one or more narrow spectral bands over which the dichroic reflective coating is highly reflecting. The retarder 56 converts the circularly-polarized ambient light to linearly-polarized ambient light which is aligned with a polarization transmission axis of the reflector 54 so that the reflector 54 transmits the linearly-polarized ambient light towards the expanded eyebox 24.

The holographic plate 2 spreads, for example, fans-out or separates, the linearly-polarized principal ray of the image light I coming from the scanning laser projector 72 into, for example, three different directions to form three different linearly-polarized rays of spread image light I which are incident on the rear side of the optical combiner 76. The first linear polarization of each of the rays of the spread image light is aligned with the polarization transmission axis of the polarization-dependent reflector 54 so that the reflector 54 transmits each of the linearly-polarized rays of the spread image light towards the retarder 56. The retarder 56 converts the polarization of each ray from the first linear polarization to a first circular polarization. Each ray then propagates from the retarder 56 to the optically-powered reflector 76, is transmitted through it and then reflected at the dichroic reflective coating to form a corresponding ray of first reflected light having a second circular polarization which is opposite to the first circular polarization.

Each ray of first reflected light propagates back through the reflector 76 towards the retarder 56. The retarder 56 converts the polarization of each ray to a second linear polarization which is orthogonal to the first linear polarization and to the polarization transmission axis of the reflector 54. Accordingly, the polarization-dependent reflector 54 reflects each ray of first reflected light back towards the retarder 56 as a corresponding ray of second reflected light. The retarder 56 then converts the polarization of each ray of second reflected light from the second linear polarization to the second circular polarization. Each ray of second reflected light then propagates from the retarder 56 to the reflector 76, is transmitted through it and then reflected at the dichroic reflective coating to form a corresponding ray of third reflected light having the first circular polarization.

Each ray of third reflected light propagates back through the reflector 76 towards the retarder 56 which converts the polarization of each ray of third reflected light from the first circular polarization to the first linear polarization which is parallel to the polarization transmission axis of the reflector 54. Accordingly, the reflector 54 transmits each ray of third reflected light to form collimated light which travels back through the holographic plate 2 as a collimated light which defines the expanded eyebox.

In effect, the reflective pancake optical combiner provides a folded optical path for the image light I. As such, use of the reflective pancake optical combiner serves to reduce the physical thickness of the eyepiece 73 resulting in a more compact eyepiece 73.

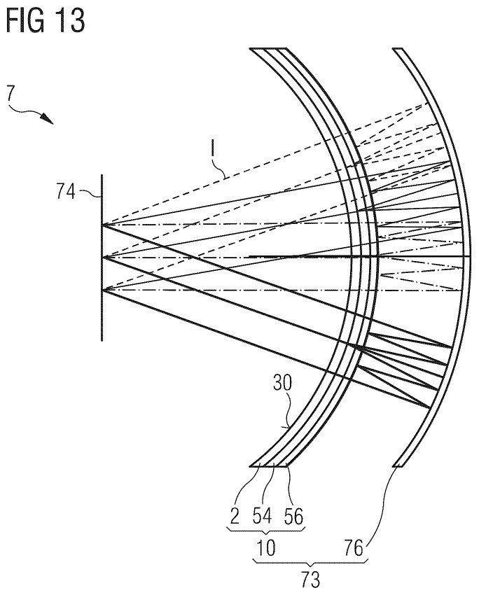

According to FIG. 13, the fan-out hologram plate 10 and, thus, the holographic plate 2 are of planar fashion. However, it is also possible that the fan-out hologram plate 10 is of curved fashion, like the reflector 76.

Otherwise, the same as to FIG. 12 may also apply to FIG. 13, and vice versa.

The holographic plates 2 illustrated in connection with FIGS. 1 to 11 can all analogously be applied for the wearable AR displays 7 of FIGS. 13 and 14.

A corresponding wearable AR display 7 is also disclosed in GB patent application 2202622.3, the disclosure content of which is hereby included by reference.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

1.-11. (canceled)

12. A method for manufacturing a holographic plate, the method comprising:
providing recording geometry optics;
providing a photopolymer; and
illuminating the photopolymer simultaneously with a first laser beam and a second laser beam thereby generating a holographic pattern in a pattern area of the photopolymer,
wherein the illuminated photopolymer results in the holographic plate,
wherein only the first laser beam runs through the recording geometry optics,
wherein a light-entrance face of the recording geometry optics for the first laser beam faces away from the photopolymer and a light-exit face of the recording geometry optics faces the photopolymer,
wherein the recording geometry optics comprise a lens array, which divides the first laser beam into a plurality of sub-beams,
wherein each one of the sub-beams illuminates most of the pattern area,
wherein each one of the sub-beams has a focal point between the pattern area and the light-entrance face,
wherein a secondary optical element is a converging lens and is located in a plane of the focal points of the sub-beams, and
wherein the lens array is composed of a plurality of spherical lenses.

13. The method according to claim 12, wherein each one of the sub-beams illuminates all of the pattern area.

14. The method according to claim 12, wherein the light-entrance face is convex.

15. The method according to claim 12, wherein the light-entrance face is planar.

16. The method according to claim 12, wherein the lens array is located at the light-exit face.

17. The method according to claim 16, wherein an optical axis of the recording geometry optics is oriented perpendicular to the photopolymer.

18. The method according to claim 12, wherein the focal points of the sub-beams are located between the light-exit face and the photopolymer.

19. The method according to claim 12, wherein the recording geometry optics is composed of a plurality of individual optical elements.

20. The method according to claim 19,
wherein the recording geometry optics is composed of a primary optical element and of the secondary optical element,
wherein the primary optical element comprises the light-entrance face and the lens array, and
wherein the secondary optical element is located between the primary optical element and the photopolymer.

21. The method according to claim 12,
wherein a diameter of the pattern area is between 1 cm and 6 cm, inclusive,
wherein a structural size of the holographic pattern is between 0.2 μm and 0.7 μm, inclusive, and
wherein each of the first laser beam and the second laser beam has a wavelength of maximum intensity between 350 nm and 870 nm, inclusive.

22. The method according to claim 12, wherein the finished holographic plate is a volume phase hologram (VPH) plate.

23. An apparatus for performing the method according to claim 12, the apparatus comprising: the recording geometry optics;
a first laser configured to generate the first laser beam;
a second laser configured to generate the second laser beam; and
a support arrangement for handling the photopolymer and the holographic plate.

24. A fan-out hologram plate comprising:
a holographic plate, which is a volume phase hologram (VPH) plate and which includes a holographic pattern in a pattern area;
a polarization-dependent reflector on which the holographic plate is arranged; and
a retarder which comprises, or which is configured to act as, a quarter-wave plate, the polarization-dependent reflector is located between the holographic plate and the retarder,
wherein the fan-out hologram plate is configured for augmented reality and/or for virtual reality glasses,
wherein the holographic pattern comprises a multiplexed fan-out hologram,
wherein a diameter of the pattern area is between 1 cm and 6 cm, inclusive, seen in top view of the holographic plate,
wherein a structural size of the holographic pattern is between 0.2 μm and 0.7 μm, inclusive, and
wherein the holographic pattern is configured for a plurality of sub-pupils, each sub-pupil is configured for a full field of view (FoV) or for a nearly full FoV.

25. A method for manufacturing a holographic plate the method comprising:
providing recording geometry optics;
providing a photopolymer; and
illuminating the photopolymer simultaneously with a first laser beam and a second laser beam thereby generating a holographic pattern in a pattern area of the photopolymer,
wherein the illuminated photopolymer results in the holographic plate,
wherein only the first laser beam runs through the recording geometry optics,
wherein a light-entrance face of the recording geometry optics for the first laser beam faces away from the photopolymer and a light-exit face of the recording geometry optics directly faces the photopolymer,
wherein the recording geometry optics comprise a lens array, which divides the first laser beam into a plurality of sub-beams,
wherein each one of the sub-beams illuminates at least 90% the pattern area,
wherein each one of the sub-beams has a focal point between the pattern area and the light-entrance face,
wherein a secondary optical element is a converging lens and is located in a plane of the focal points of the sub-beams, and
wherein the lens array is composed of a plurality of spherical lenses.
